(19) United States
(12) Patent Application Publication
(10) Pub. No.: US 2013/0193037 A1
(43) Pub. Date: Aug. 1, 2013

(54) SCREENING MACHINE WITH SEGMENTED SCREEN PANELS, AND RELATED METHODS

(71) Applicant: Rotex Global, LLC, Cincinnati, OH (US)

(72) Inventors: Craig Richard Dressler, Ludlow, KY (US); E. Stephens Paxton, Wyoming, OH (US); Jeffrey D. Pielage, Cincinnati, OH (US)

(73) Assignee: ROTEX GLOBAL, LLC, Cincinnati, OH (US)

(21) Appl. No.: 13/793,939

(22) Filed: Mar. 11, 2013

Related U.S. Application Data
(63) Continuation-in-part of application No. 12/883,422, filed on Sep. 16, 2010.
Application No. 12/883,422 is a continuation-in-part of application No. 12/261,117, filed on Oct. 30, 2008, now abandoned.

(51) Int. Cl. B07B 1/46; B07B 1/28

(52) U.S. Cl. CPC B07B 1/46; B07B 1/28
USPC 209/405; 29/428

(57) ABSTRACT

A screen panel assembly is used with a screening machine. The screen panel assembly includes first and second generally planar screen panels and a coupling between the first and second screen panels that includes a compression clip jaw to temporarily secure the screen panels together. An overlap region between the first and second screen panels permits lifting of the second screen panel by a lifting force exerted upon the first screen panel while inhibiting the passage of material being screened between the two adjacent screen panels.

This is a continuation in part of U.S. patent application Ser. No. 12/883,422, filed Sep. 16, 2010, which is in turn a continuation in part of U.S. patent application Ser. No. 12/261,117, filed Oct. 30, 2008. The application Ser. Nos. 12/883,422 and 12/261,117 applications are hereby incorporated by reference in their entireties.

### BACKGROUND OF THE INVENTION

This invention relates to screening machines or separators of the type used to separate or classify mixtures of solid particles of different sizes.

In screening machines or separators of the type described, a screen (which may be woven, an aperture plate or another design) is mounted and pre-tensioned in what is often called a “screen pane” or “screen deck” that includes a supporting peripheral frame around the perimeter of the screen. The terms “screening machine” and “separator” and respective derivatives thereof are herein used interchangeably. A main housing of the screening machine supports one more of the screen panels, as well as agitating structures that shake or vibrate the solids deposited on the screen panels.

The screen panels are often removed from the screening machines for cleaning, replacement, readjustment or installation of a screen of a different mesh size or the like. In large commercial screening machines, the screen panels are inserted through and removed from a longitudinal end of the machine. In accordance with this movement of the screen panels, sufficient space must be devoted near the end of the machine, such that the generally horizontal screen panels may be inserted into and removed from the housing of the screening machine. Moreover, screen panels in large commercial screening machines tend to be relatively large, making their insertion and removal difficult or awkward at best, especially for a sole operator in tight working conditions.

Many machines of this type are used to separate particulate material which, over time, often clogs or blocks the screen mesh. Commonly, an agitating mechanism is included in the machine to unblock the mesh by dislodging the clogging material. Often, the agitating mechanism is a number of balls captured by a ball tray and accessible to the screen mesh. In large commercial screening machines, the agitating structures may be also inserted and removed respectively through the end of the machine, as described above with respect to the screen panels, thereby presenting similar space requirements. Moreover, known agitating structures tend to be large and relatively heavy, making their insertion into and removal from the housing of the screening machine a particularly difficult and work-intensive task for the operators involved.

It is evident, therefore, that a screening machine and screening machine components are needed that address these and other known problems associated with conventional screening machines.

### SUMMARY OF THE INVENTION

These and other shortcomings in the prior art have been addressed in various embodiments of this invention. In a first embodiment, a screen panel assembly is provided for use with a screening machine. The screen panel assembly includes first and second generally planar screen panels and a coupling between the screen panels. The coupling includes a projection from the first screen panel received in a receiving jaw of the second screen panel. The coupling further includes a resilient biasing member carried by either the projection or the receiving jaw, the resilient biasing member being compressed between the projection and the receiving jaw.

In another embodiment, a screen panel is provided that is configured to be coupled with a like screen panel as part of a screen panel assembly. The screen panel includes a frame, a pre-tensioned screen supported on the frame, a receiving jaw on a leading end of the frame, and a projection on a trailing end of the frame opposite the leading end. The receiving jaw is configured to receive the projection of a like screen panel. The screen panel further includes a resilient biasing member carried by either the projection or the receiving jaw, the resilient biasing member being configured to be compressed between the receiving jaw and the projection of the like screen panel.

In yet another embodiment, a screening machine is provided. The screening machine includes a main housing and a screen panel assembly having first and second generally planar screen panels. The screen panel assembly further includes a coupling between the screen panels configured to permit movement of the first and second screen panels by a force exerted upon the first screen panel. The coupling includes a projection from the first screen panel and a receiving jaw on the second screen panel configured to receive the projection. The coupling further includes a resilient biasing member carried by either the projection or the receiving jaw. The resilient biasing member is compressed between the projection and the receiving jaw. The coupling further includes an overlap region between the first and second screen panels engageable to thereby permit lifting of the second screen panel by a lifting force exerted upon the first screen panel.

In another embodiment, a method is provided for installing a screen panel assembly in a screening machine. The method includes positioning a first screen panel on an agitating structure of the screening machine so that a limiting tab on the first screen panel engages a flange on the agitating structure. The method further includes joining a second screen panel with the first screen panel to form the screen panel assembly. Engagement of the limiting tab on the first screen panel with the flange on the agitating structure prevents the first screen panel from moving when then the second screen panel is joined with the first screen panel.

In embodiments having a screen panel assembly that is made up of two or more generally planar screen panels, insertion and removal of the screen panel assembly respectively into and out of the main housing of the screening machine is greatly facilitated. Similarly, in embodiments having an agitating structure that includes segmented co-planar trays, insertion and removal of the agitating structure in conjunction with the screen panels is likewise facilitated.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a partially broken-away perspective view of a screen panel assembly being inserted into a screening machine in accordance with one embodiment of this invention;

FIG. 2 is a partially broken-away perspective view of a pair of screen panels according to one embodiment of this invention;

FIG. 3 is an enlarged partially broken-away cross-sectional view of the screen panels of FIG. 2 taken along line 3-3 of FIG. 2;

FIG. 4 is an enlarged partially broken-away cross-sectional view of the screen panels of FIG. 2 taken along line 4-4 of FIG. 2;

FIG. 5 is an enlarged partially broken-away and disassembled perspective view of the screen panels of FIG. 2 taken along line 5-5 of FIG. 2;

FIG. 6 is an enlarged partially broken-away and assembled perspective view of the screen panels of FIG. 2 taken along line 5-5 of FIG. 2;

FIG. 7 is an enlarged partially broken-away perspective view of the latching mechanism joining adjacent screen panels of one embodiment of this invention;

FIG. 8 is a partially broken-away bottom perspective view of a pair of screen panels according to another embodiment of the invention;

FIGS. 9A and 9B are enlarged partially broken-away cross-sectional views of the interaction between the ledge, jaw, and compression clip of the screen panels of FIG. 8;

FIG. 10A is a partially broken-away perspective view of a screen panel assembly being inserted into a screening machine in accordance with another embodiment of the invention;

FIG. 10B is a view like FIG. 10A, and showing a trailing screen panel being brought into position relative to a leading screen panel;

FIG. 10C is an enlarged view showing the interaction between a limiting tab on the leading screen panel and a flange on a tray of an agitating structure;

FIG. 10D shows the leading and trailing screen panels being joined together;

FIG. 10E is an enlarged view and shows the screen panel assembly, including the joined leading and trailing screen panels, being lifted so the limiting tab on the leading screen panel clears the flange on the tray;

FIG. 10F shows a third screen panel being brought into position relative to the trailing screen panel;

FIG. 10G shows the third screen panel joined with the trailing screen panel, and the screen panel assembly being lifted so the limiting tab on the trailing screen panel clears the flange on the tray;

FIG. 10H shows the screen panel assembly aligned with and secured with the tray of the agitating structure;

FIG. 10I is taken along line 10I-10I in FIG. 10H, and shows a tongue extending from the flange on the tray of the agitating structure received in a lug spacing formed by the lug on the third screen panel; and

FIG. 10J shows the screen panel assembly and agitating structure installed in the screening machine.

### DETAILED DESCRIPTION OF THE INVENTION

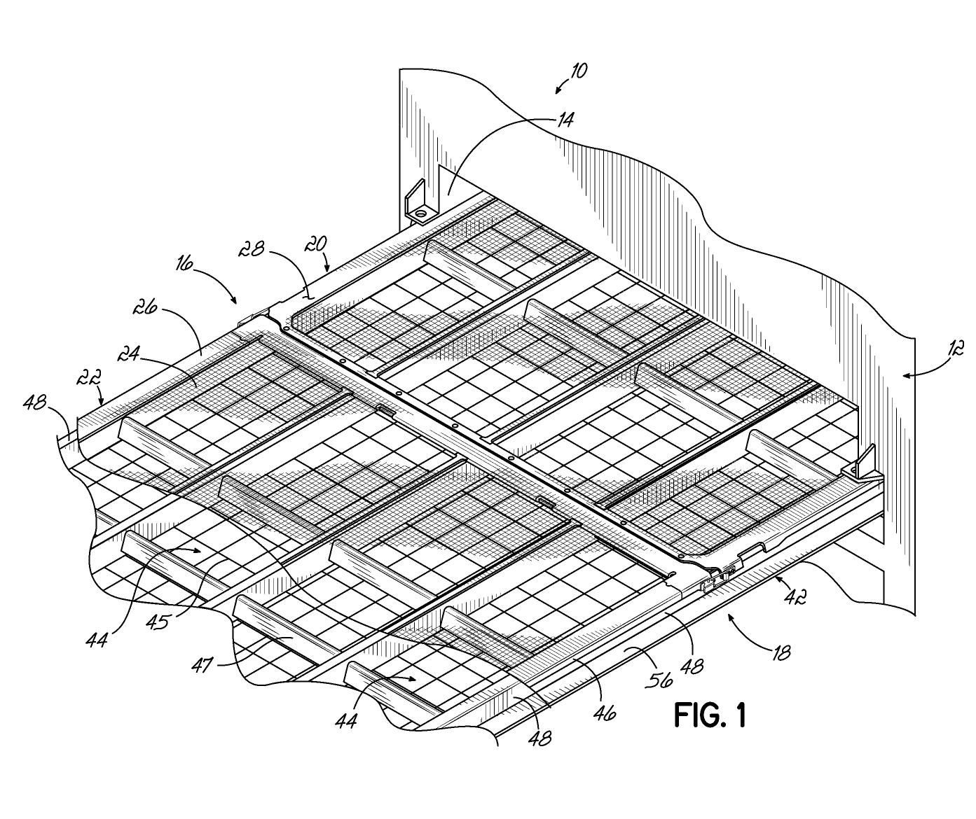

With reference to the figures, and more particularly to FIG. 1, a screening machine or separator 10 includes a main housing 12 having an access opening 14 located at a longitudinal end of the housing 12 for inserting and removing screening components such as a screen panel assembly 16 and an agitating structure 18 cooperating with the screen panel assembly 16 to segregate solids or other material (not shown) deposited on the screen panel assembly 16.

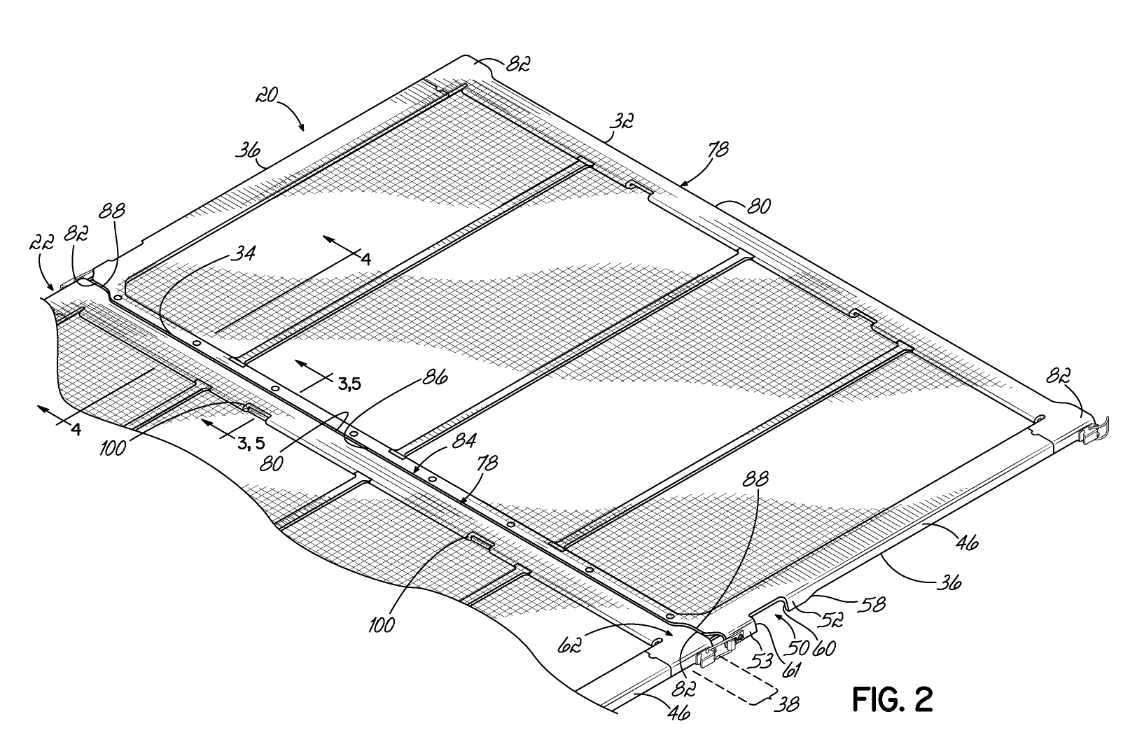

With reference to FIGS. 1-2, the screen panel assembly 16 of this exemplary embodiment is in the form of a segmented assembly that includes a first, leading screen panel 20 and a second, trailing screen panel 22 that are substantially identical to and interchangeable with one another. It is contemplated that the screen panel assembly 16 may instead have any number of screen panels other than two including, without limitation, a single screen panel, and still fall within the scope of this invention. Each of the screen panels 20, 22 includes a pre-tensioned screen 24 supported about the respective perimeters of the screens by a frame 26 and further includes a top face 28 and an opposite bottom face 30. The screen panels 20, 22 each have spaced longitudinal leading and trailing ends 32, 34 and spaced lateral sides 36 and are engageable with one another along adjacent ends to define an overlap a region 38. The screen panels 20, 22 are generally symmetric about a longitudinal center line.

The screen mesh material is pre-tensioned and mounted between the screen frame according to one embodiment of the screen panel according to this invention and secured to the frame via a cured or baked on enamel around the perimeter of the screen surface of the screen panel. Alternatively, epoxies or other materials may be utilized to secure the pre-tensioned screen material to the frame.

The overlap region 38 includes a seal member 40 mounted to one of the screen panels and prevents or at least minimizes the likelihood of material deposited on the screen panels 20, 22 from falling onto the underlying agitating structure 18.

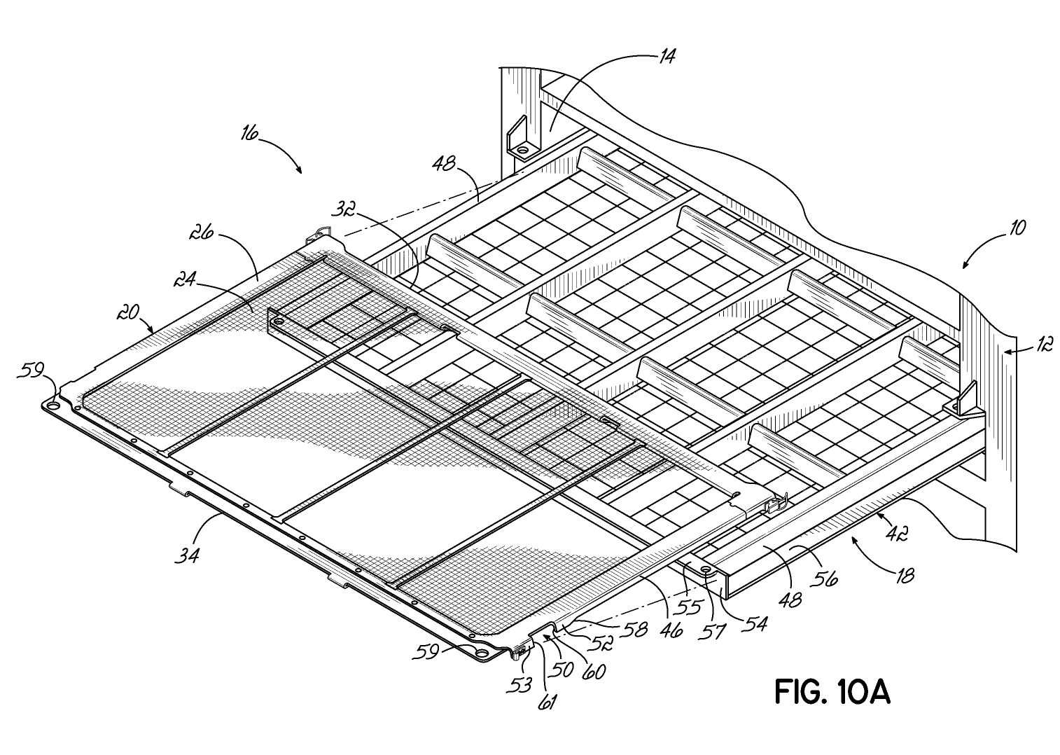

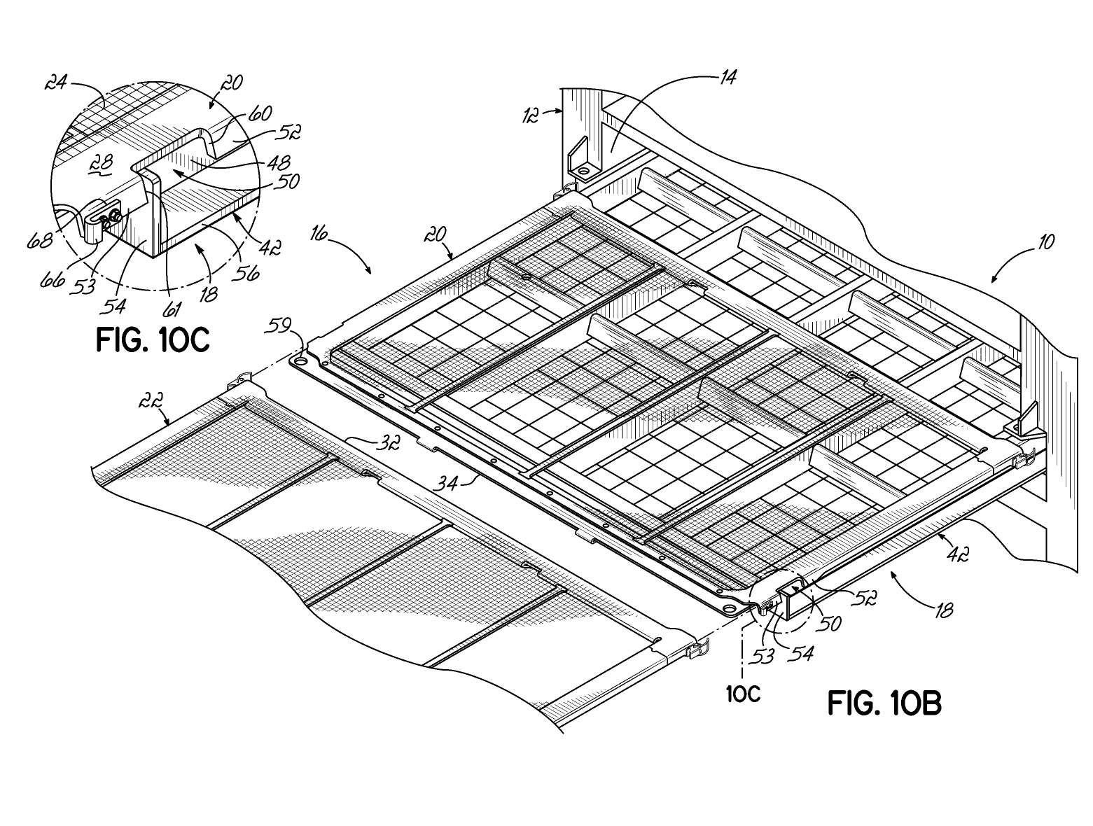

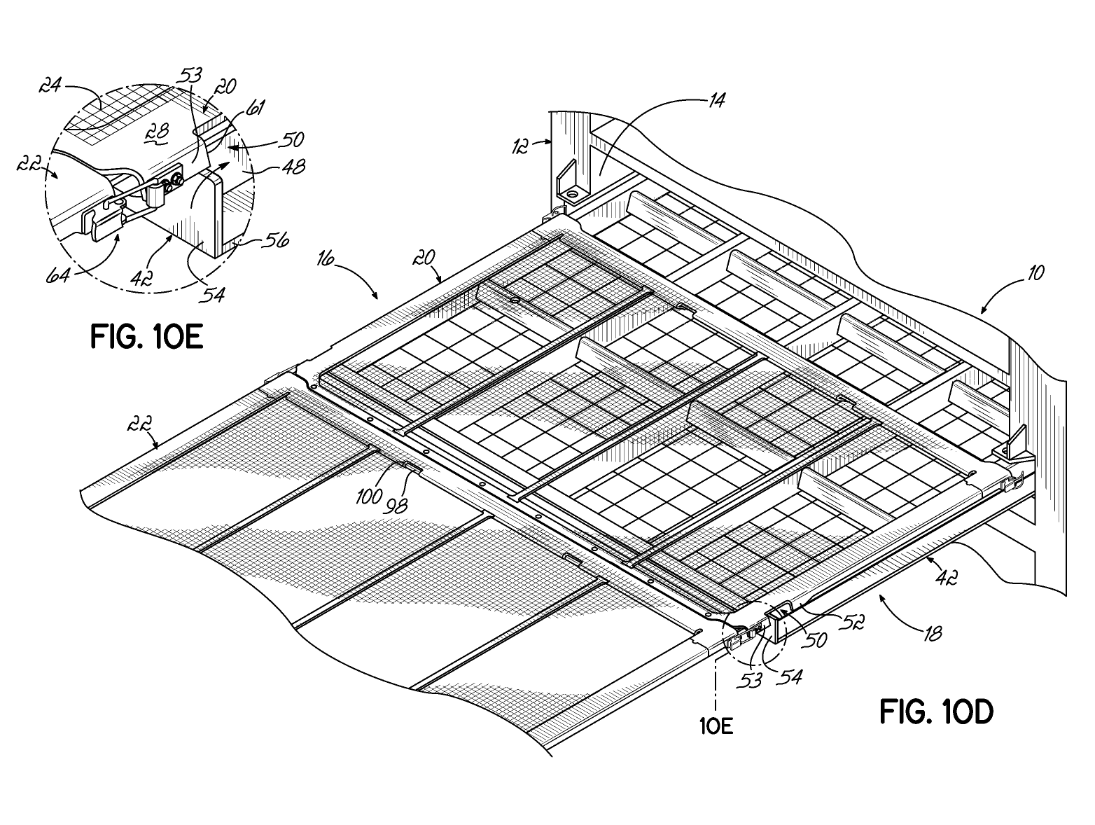

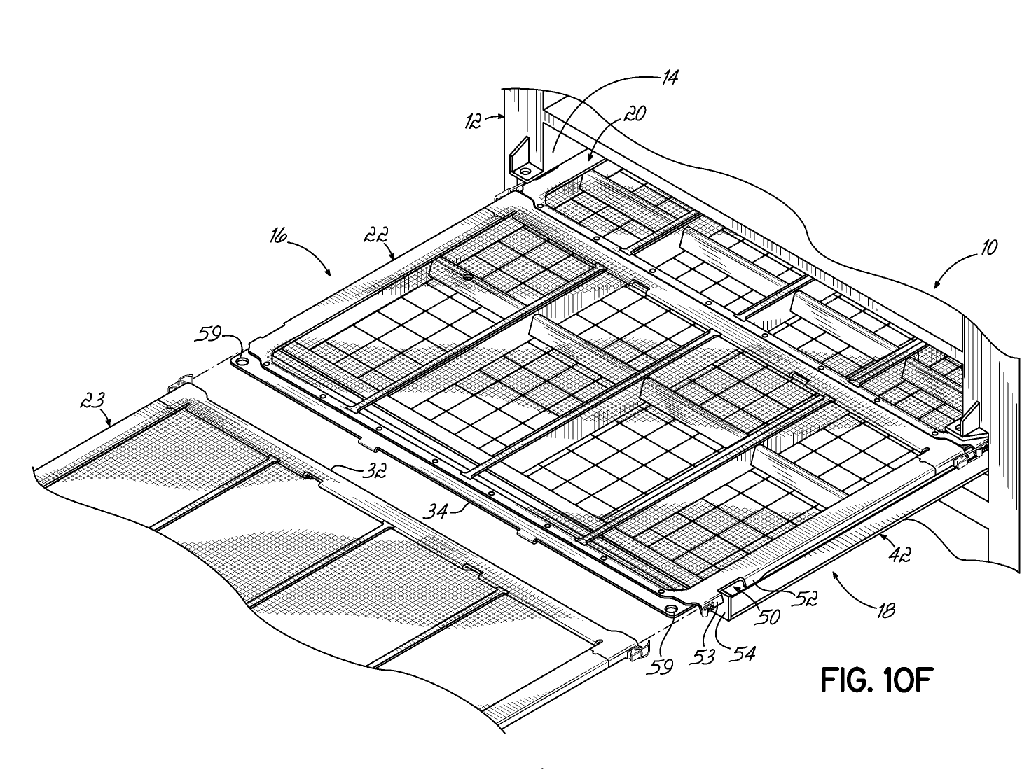

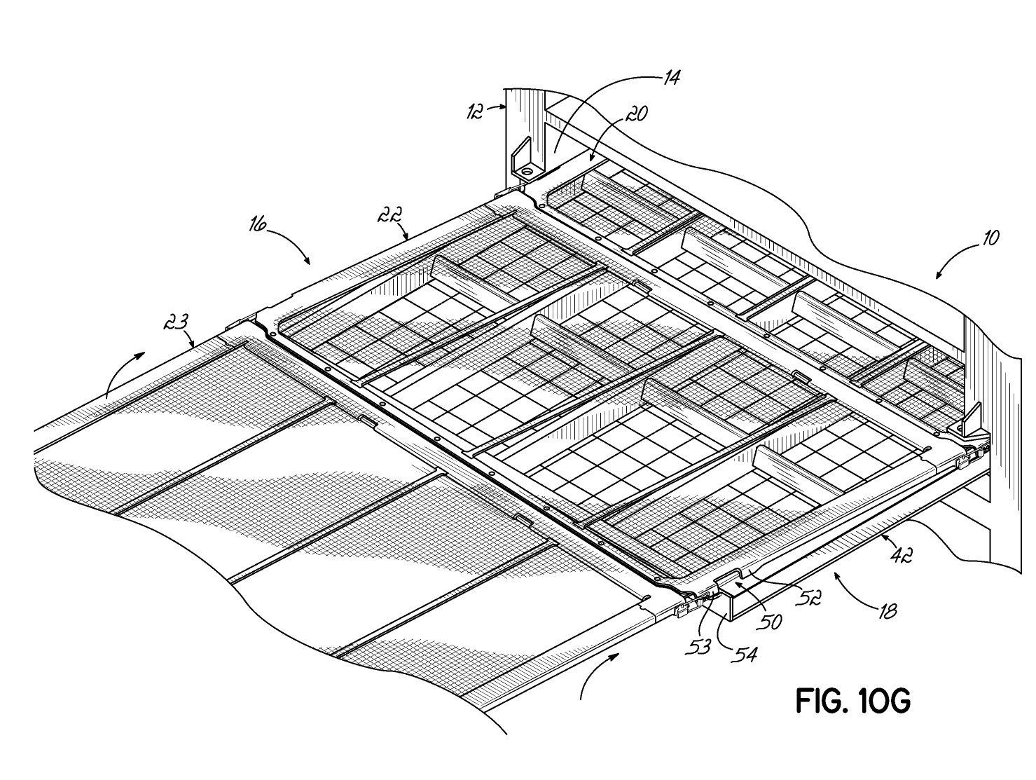

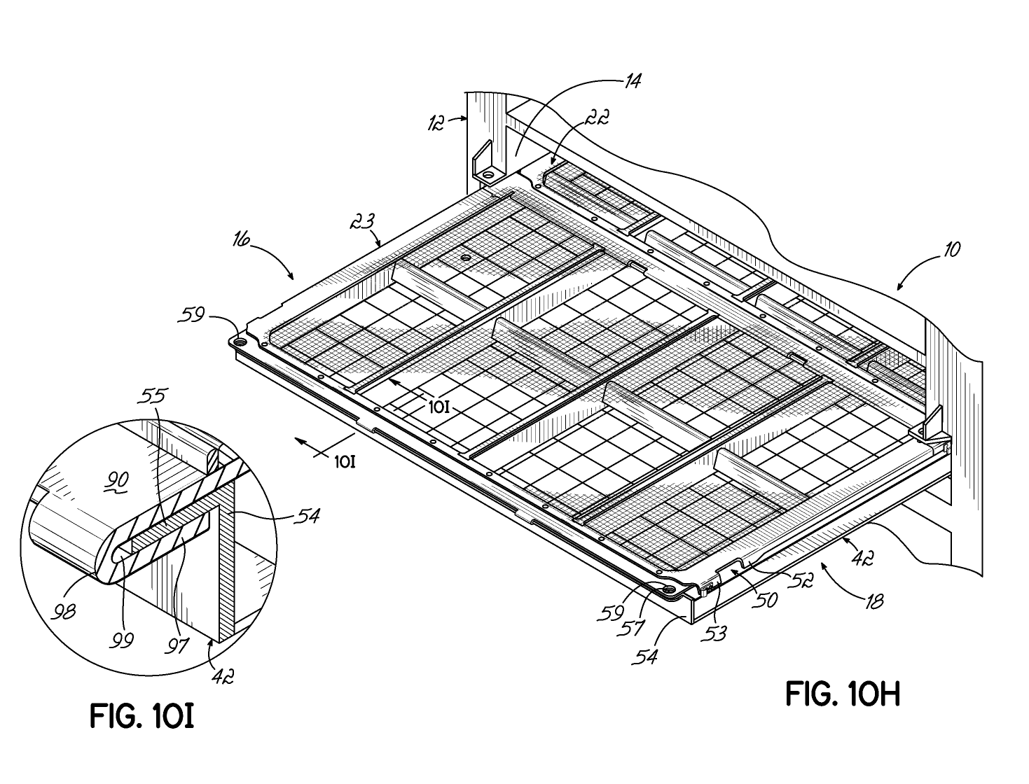

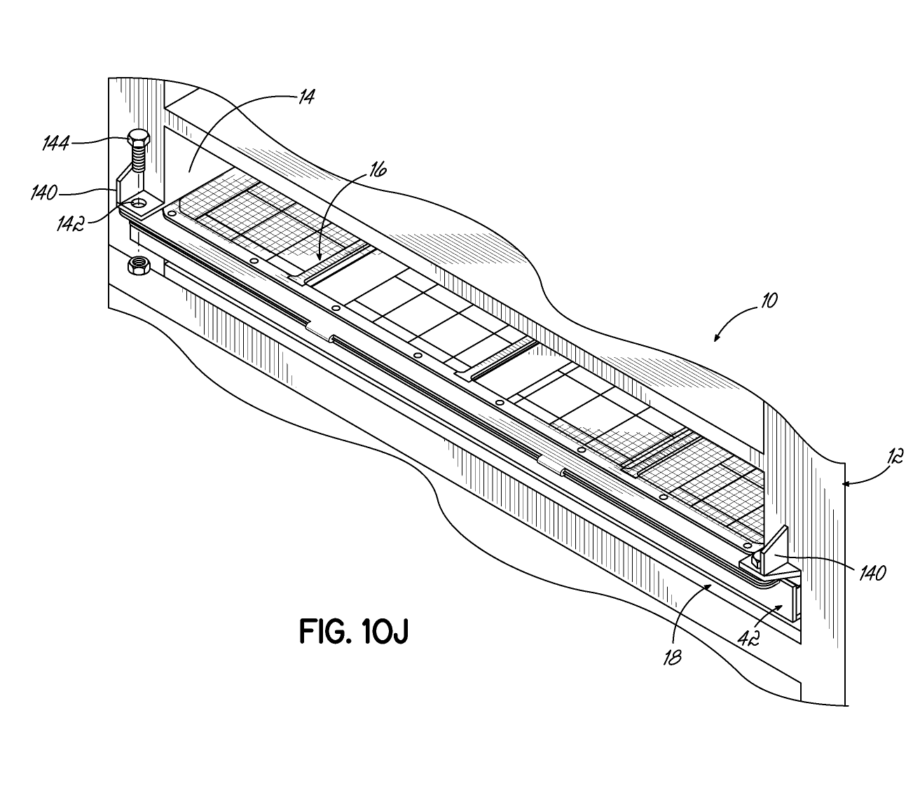

In this exemplary embodiment, the agitating structure 18 is in the form of a segmented tray assembly having multiple, generally coplanar trays 42 that are also engageable with one another through a tray coupling (not shown). Additional details of one embodiment of the agitating structure 16 are detailed in U.S. Published patent application No. 2010-0108579, which is incorporated herein by reference in its entirety. Each of the trays 42 in this exemplary embodiment is partitioned into several compartments 44 (FIG. 1). Longitudinally extending lips 46 of each of the screen panels 20, 22 engage respective side walls 48 of the trays 42 and thereby determine a position of the screen panels 20, 22 relative to the trays 42 when these components are engaged with one another within the main housing 12 (FIG. 1). Each of the longitudinal lips 46 extends only partially along the respective length of the associated screen panel 20, 22 to define a notch 50 between portions of the lips 46 and stopping elements in the form of first and second limiting tabs 52, 53, which are situated on opposite sides of the notch 50 (FIG. 10A).

Each tray 42 also includes a flange 54 projecting vertically adjacent the lips of the screen panels and a longitudinal, generally horizontal projection 56 (FIG. 10A). In the embodiment shown, the flange 54 extends substantially the entire width of the tray 42. A generally horizontal tongue 55 extends from an upper region of the flange 54. The tongue 55 optionally includes locating bores 57 configured to align with optional locating bores 59 on the panels 20, 22, as will be described further below.

Each of the individual trays 42 of the illustrated embodiment includes several compartments 44 that hold agitating elements that move and thereby vibrate the solids deposited on the screen panel assembly 16. The agitating elements, although not shown, may for example and without limitation include balls made of metal, plastic or other suitable material and are held within the compartments 44. The agitating elements are supported by a bottom support screen 45 and confined in the compartments 44 by partition walls 47 defining the compartments 44.

It is contemplated, however, that an alternative agitating structure may have other shapes and/or include any number of trays other than the two trays of this exemplary embodiment. Such alternatives include, without limitation, an agitating structure having a single tray rather than a segmented tray assembly.

Referring to FIGS. 1 and 2, exemplary screen panels 20, 22 according to one embodiment of this invention are shown. Each screen panel 20, 22 is substantially identical to each other. The frame 26 of each screen panel includes the downwardly turned lip 46 extending longitudinally on each lateral side edge of the screen panel 20, 22. The lip 46 includes the tabs 52, 53. The tab 52 has a generally sloped leading edge 58 and a generally vertically oriented trailing edge 60 adjacent to the notch 50. The tab 53 has a generally vertically oriented leading edge 61 adjacent to the notch 50 and opposite the trailing edge 60 of the tab 52 (FIG. 10A).

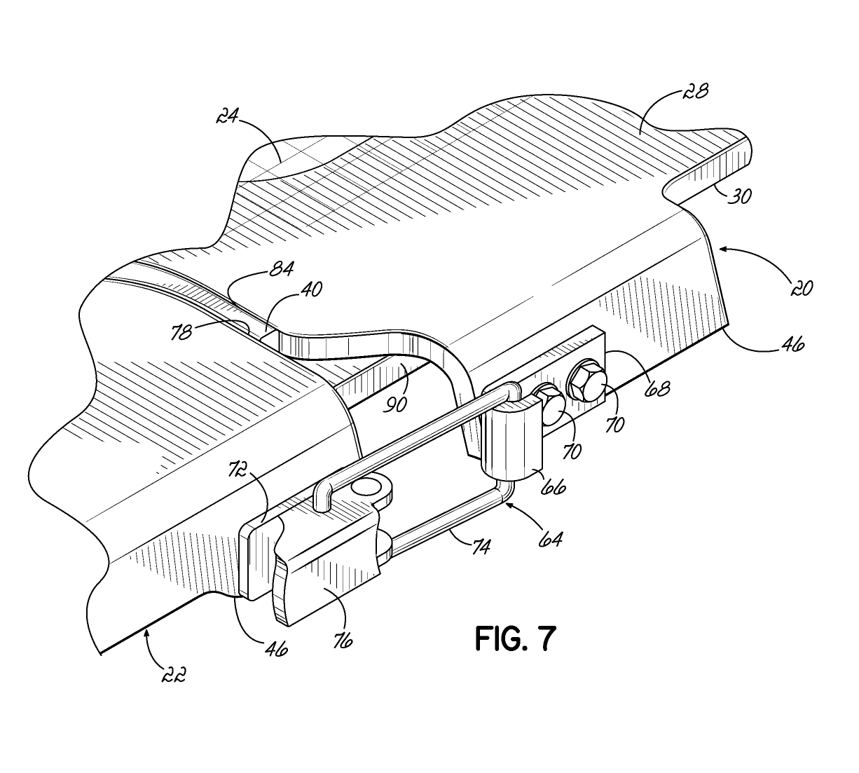

The adjacent screen panels are joined together by a coupling 62 which in one embodiment includes one or more latching mechanisms 64. One example of the latching mechanism 64 is shown particularly in FIGS. 1, 2 and 7 is an over-center draw latch. One component of the latching mechanism 64 is a receiving hook 66 on the trailing end 34 of each screen panel 20, 22. The receiving hook 66 projects from a base portion 68 and is mounted to the lip 46 via mechanical fasteners 70, two of which are shown in FIGS. 1, 2 and 7 as bolts, although other mounting mechanisms may be utilized. The base portion 68 is mounted via the bolts 70 to the lip 46 so that the hook 66 is juxtaposed to the adjacent, leading screen panel 20. On the adjacent screen panel, a latch base 72 of the latching mechanism 64 is likewise mounted via a pair of mechanical fasteners 70 such as bolts to the downwardly turned lip 46. A generally rectangular-shaped bail member 74 is pivotally coupled to a latch body 76 which is similarly pivotally coupled to the latch base 72 as is well known according to standard over-center draw latch design. Two latching mechanisms 64 are provided for each pair of adjacent screen panels 20, 22, one on each opposite lateral side edge according to one embodiment of this invention. The latching mechanisms 64 draw the confronting adjacent longitudinal ends 32, 34 of the screen panels 20, 22 together.

As shown in FIGS. 1-7, the leading longitudinal end 32 of each screen panel 20, 22 includes a contoured edge 78 with a generally linear central portion 80 bounded on each end by shoulder portions 82. The contoured leading edge 78 of each screen panel 20, 22 is shaped and configured to mate with a contoured trailing edge 84 of each screen panel which includes a generally linear central portion 86 bounded on each end by jog portions 88. Each jog 88 is configured to mate with the adjacent shoulder 82 of the adjacent screen panel. The leading and trailing contoured edges 78, 84 of the screen panels 20, 22 are positioned proximate the top face 28 of each screen panel. However, while the contoured leading edge 78 of each screen panel 20, 22 is at a distal end of the respective screen panel, the contoured trailing edge 84 of each screen panel is recessed relative to the distal edge of the screen panel such that a ledge 90 projects rearwardly beyond the trailing edge 84 at a recessed level relative to the top face 28 along a substantial portion of the trailing end 34 of the screen panel 20, 22.

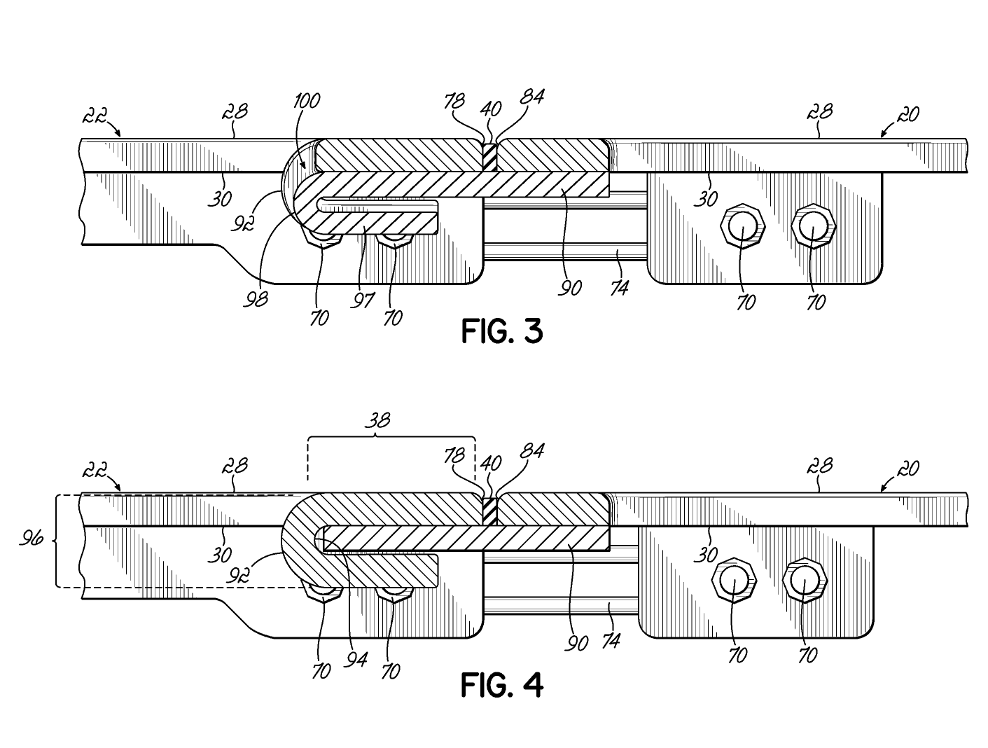

The frame 26 of each screen panel 20, 22 along the leading end 32 thereof includes a hem 92 offset or recessed from the distal edge of the screen panel. The hem 92 includes a jaw 94 which presents an opening facing the leading end 32 of the screen panel 20, 22. The jaw 94 is sized and configured to receive therein the ledge 90 along the trailing end 32 of the leading screen panel 20 so as to provide one aspect of the coupling 62 between the adjacent screen panels 20, 22. The ledge 90 of the leading screen panel 20 mating with the hem 92 and jaw 94 of the trailing screen panel 22 provides an overlap portion 96 between the adjacent screen panels 20, 22 as shown particularly in FIG. 4. The cross-sectional view of FIG. 4 shows the ledge 90 of the leading screen panel 20 seated within the jaw 94 of the trailing screen panel 22. The seal member 40 is mounted along the contoured edge 84 of the trailing end 34 of the leading screen panel 20 atop the ledge 90. When the adjacent screen panels 20, 22 are joined together, the seal member 40 is compressed between the contoured edges 78, 84 as shown in FIGS. 3 and 4.

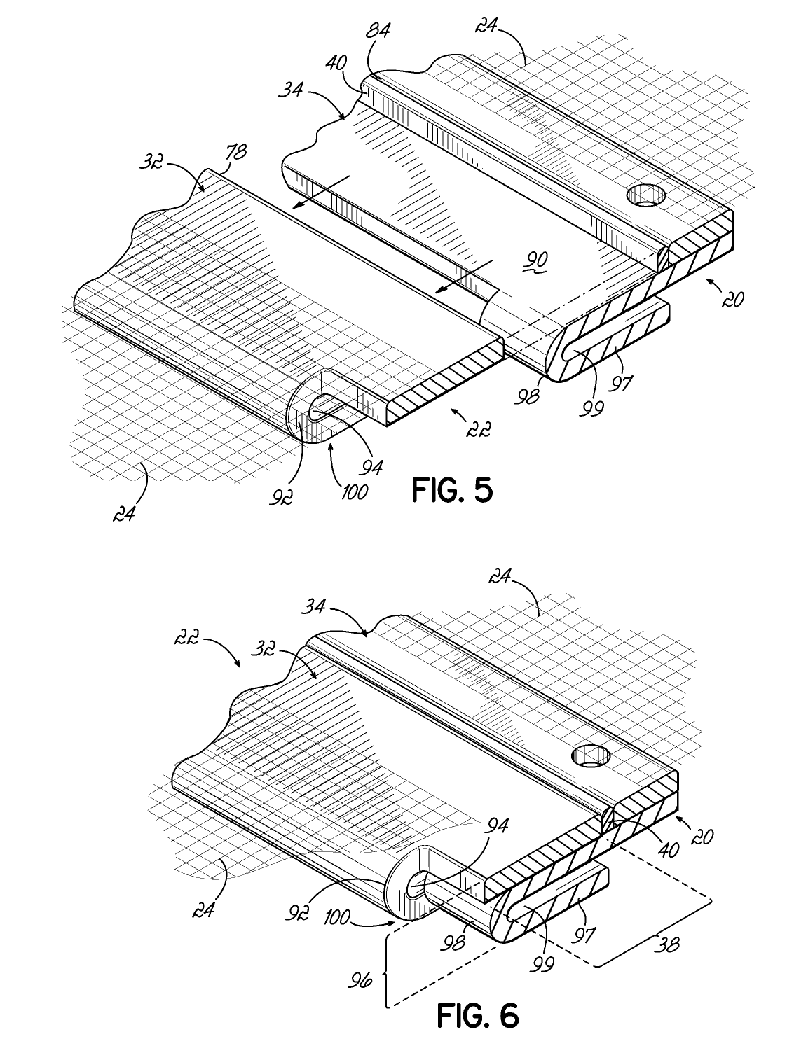

Another aspect of the coupling 62 between the adjacent screen panels 20, 22 according to various embodiments of this invention are lugs 98 which extend from the ledge 90 along the trailing end 34 of the screen panel 20. Two such lugs 98 are shown in the drawings. In particular, in FIGS. 5 and 6, one of the lugs 98 is shown as a folded under extension from the ledge 90, and includes a lug arm 97 that is spaced from and extends under the ledge 90, thereby forming a lug spacing 99 between the lug arm 97 and the ledge 90. Each lug 98 is seated within a seat 100 formed in a gap of the hem 92 of the leading edge 32 of the trailing screen panel 22. The seats 100 are particularly shown in FIGS. 1 and 2 and are spaced across the width of the screen panel. The lug 98 positioned within the seat 100 is likewise shown in cross-sectional view of FIG. 3. The combination of the lugs 98 and the seats 100 on the adjacent mating ends 32, 34 of the screen panels 20, 22 helps to center the screen panels in a lateral direction relative to one another as well as providing an additional mechanism for coupling the panels.

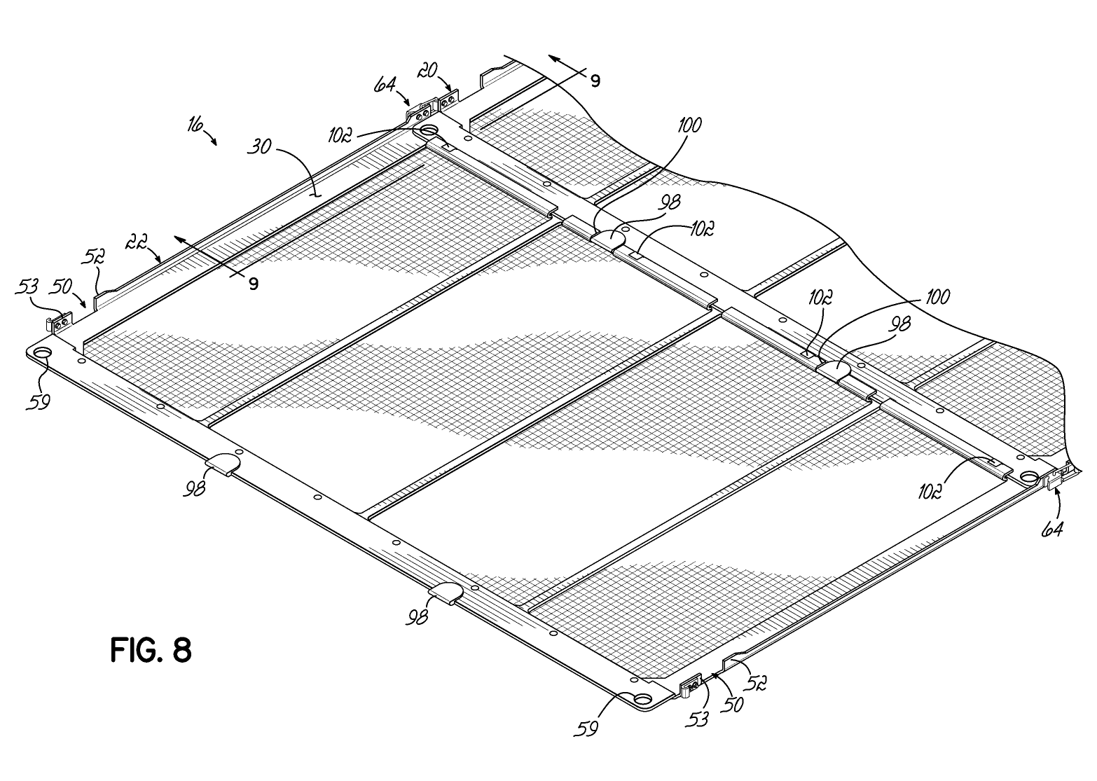

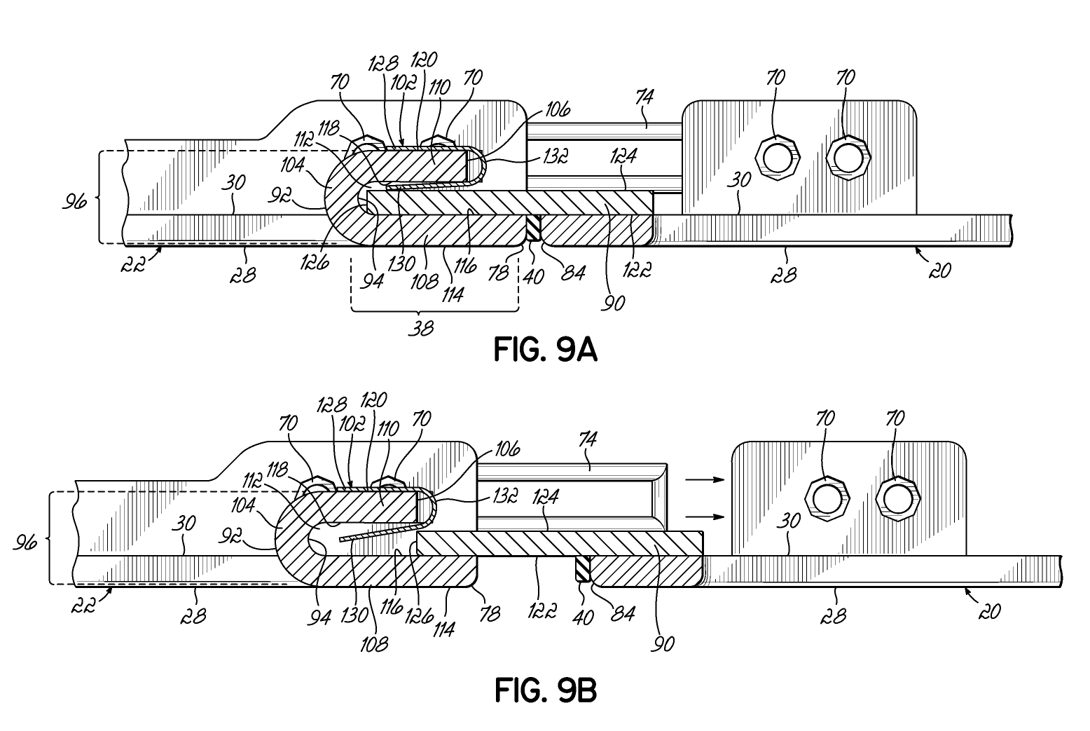

Another aspect of the coupling 62 between the adjacent screen panels 20, 22 according to various embodiments of this invention is shown in FIGS. 8, 9A, and 9B and includes a plurality of resilient biasing members for joining the panels 20, 22. In the embodiment shown, for example, the resilient biasing members are in the form of four compression clips 102 are disposed along the interface of the panels 20, 22 between the lateral sides 36. The compression clips 102 encourage a tight fit between the ledge 90 of the leading screen panel 20 and the hem 92 and jaw 94 of the trailing screen panel 22. In particular, each compression clip 102 includes portions that are resiliently moveable with respect to one another, such as pivotally moveable.

As shown in FIGS. 9A and 9B, the hem 92 (which includes the jaw 94) extends through a curved transition region 104 and terminates at a terminal end 106. The jaw 94 includes an upper jaw portion 108 and a lower jaw portion 110. A jaw opening 112 is formed between the upper and lower jaw portions 108, no, and as described above, the opening 112 faces the leading end 32 of the screen panel 22. Advantageously, the upper and lower jaw portions 108, no are generally parallel with each other and with the top face 28 of the panel 22. Because FIGS. 8, 9A, and 9B depict features from the bottom of the panels 20, 22, the lower jaw portion 110 is oriented above the upper jaw portion 108, but this merely reflects the presentation of the drawings.

The upper jaw portion 108 includes an upper surface 114 that is generally co-planar with the top face 28 of the screen panel 22. The upper jaw portion 108 also includes a lower surface 116 which is generally opposite the upper surface 114 and partially defines the jaw opening 112. The upper and lower surfaces 114, 116 are generally parallel with each other.

The lower jaw portion 110 includes an upper surface 118 which is generally opposed from the lower surface 116 of the upper jaw portion 108 and partially defines the jaw opening 112. The lower jaw portion 110 further includes a lower surface 120 which is generally opposite the upper surface 118. The upper and lower surfaces 118, 120 are generally parallel with each other.

The ledge 90, which is received in the jaw opening 112 when the screen panels 20, 22 are joined together, generally includes an upper ledge surface 122 and a lower ledge surface 124 and terminates at a terminal end 126 which is generally away from the trailing edge 84. The upper and lower ledge surfaces 122, 124 are generally parallel with each other and with the top face 28 of the screen panel 20.

The compression clips 102 are compressed between the ledge 90 and the jaw 94 when the ledge is inserted into the jaw opening 112. Each compression clip 102, one of which is shown in FIGS. 9A and 9B, has a generally U-shaped body that includes a first wing 128 and a second wing 130. The wings 128, 130 are connected through a generally curved junction region 132. The clip 102 is resiliently deformable and the wings 128, 130 tend to resist being deformed or deflected either toward or away from each other.

In the embodiment shown, the clip 102 is carried by the lower jaw portion 110 and extends into the jaw opening 112. In particular, the first wing 128 of the clip 102 is secured to the lower surface 120 of the lower jaw portion 110 and the junction region 132 is generally adjacent the terminal end 106 of the hem 92. The second wing 130 of the clip 102 extends into the jaw opening 112 between the upper surface 118 of the lower jaw portion no and the lower surface 116 of the upper jaw portion 108. As shown, the second wing 130 is generally adjacent the upper surface 118 of the lower jaw portion no near the terminal end 106, and extends somewhat an angle from the terminal end 106 in the direction of the curved region 104 and the upper jaw portion 108. As further shown, the first wing 128 is secured to the lower jaw portion no while the second wing 130 is free and generally unsecured in the jaw opening 112.

When the panels 20, 22 are joined, this aspect of the coupling 62 is made when the ledge 90 of the leading screen panel 20 is inserted into the jaw opening 112 of the trailing screen panel 22 and engages the clip 102. In particular, as the ledge 90 is inserted into the jaw opening 112 toward the curved region 104 of the hem 92, the terminal end 126 of the ledge 90 enters the jaw opening 112 and the ledge 90 contacts the second wing 130 of the clip 102. Further insertion of the ledge 90 causes the second wing 130 to deflect generally toward the first wing 128 and the lower jaw portion 110, as shown in FIG. 9A. The clip 102 is thereby compressed between the ledge 90 and the jaw 94. The clip 102 tends to resist this deflection and the second wing 130 resiliently biases the ledge 90 into contact with the jaw 94. In particular, the clip 102 presses against the lower ledge surface 124 of the ledge 90. This presses the upper ledge surface 122 of the ledge 90 against the lower surface 116 of the upper jaw portion 108. The close engagement of the surfaces 116, 122 provides a further seal that inhibits material leakage through the connection of the ledge 90 and the jaw 94. Thereby, the ledge 90 is held captive in the jaw 94 and the clip 102 encourages a tight fit between the ledge 90 and the jaw 94.

The ledge 90 can be removed from the hem 92 and the jaw 94 to break this aspect of the coupling 62. When the ledge 90 is thus removed, as shown in FIG. 9B, the clip 102 restores to its previous condition, with the second wing 130 being free and deflecting back toward the upper jaw portion 108. Advantageously, by securing the first wing 128 of the clip 102 to the lower surface 120 of the lower jaw portion 110, this point of securement is out of the way of the jaw 94 and is not disturbed when the ledge 90 is inserted into or removed from the jaw 94.

While the embodiment shown includes resilient biasing members in the form of generally U-shaped clips 102 that are carried by the lower jaw portion 110, other shapes and configurations are also possible. For example, the resilient biasing member could be in the form of a generally planar leaf spring where one end is attached to the upper surface 118 of the lower jaw portion 110 and the other end is free and extends in the jaw opening 112 toward the upper jaw portion 108. Further, the resilient biasing member could be carried by the upper jaw portion 108. Further still, the resilient biasing member could be carried by the ledge 90 on either the upper ledge surface 122 or the lower ledge surface 124. In addition, while the embodiment shown includes resilient biasing members as well as latching mechanisms 64 and lugs 98/seats 100, a screen panel assembly could be constructed having only resilient biasing members, and none of or any of latching mechanisms 64 and lugs 98/seats 100.

With reference to FIGS. 10A-10J, the functionality of the limiting tabs 52, 53 of the screen panels is described in further detail. In particular, the limiting tabs 52, 53 provide structure for interfacing with the agitating structure 18 to enhance joining multiple screen panels (such as screen panels 20, 22) into a screen panel assembly 16. The limiting tabs 52, 53 also provide structure for interfacing with the agitating structure 18 to enhance disassembly a screen panel assembly 16 into separate screen panels.

FIG. 10A shows the screen panel 20 being moved into position relative to the tray 42 of the agitating structure 18. The tray 42 is already partially received in the access opening 14 in the main housing 12 of the screening machine 10. The leading screen panel 20 is positioned above the tray 42 so that the screen panel 20 can be lowered onto the side walls of the tray 42, with the leading end 32 nearer the access opening than the trailing end 34. The screen panel 20 may be moved toward the access opening 14, with the lip 46 of the screen panel riding on the flange 54 of the tray 42. Continued movement of the screen panel 20 toward the access opening 14 causes the sloped leading edge 58 to come into engagement with the flange 54, thereby lifting the screen panel 20 relative to the tray 42 before the screen panel 20 drops when the flange 54 enters the notch 50 (FIGS. 10B and 10C). A small amount of further movement of the screen panel 20 toward the access opening 14 brings the leading edge 61 of the tab 53 into contact with the flange 54, which tends to inhibit further movement of the screen panel 20 toward the access opening 14 (FIGS. 10B and 10C).

With continued reference to FIG. 10B, the trailing screen panel 22 can be moved into position relative to the leading screen panel 20 for joining the screen panels 20, 22 together. As shown in FIG. 10D, the trailing screen panel 22 can be pushed into engagement with the leading screen panel 20, and the coupling 62 between the screen panels 20, 22 can be established. For example, the jaw 94 of the trailing screen panel 22 can be pushed onto the ledge 90 of the leading screen panel 20, and the compression clips can hold the ledge 90 in the jaw 94. Also, the lugs 98 of the leading screen panel 20 can be seated in the seats 100 of the trailing screen panel 22. In addition, the latching mechanisms 64 can be used to secure the first and second screen panels 20, 22.

As the trailing screen panel 22 is pushed together with the leading screen panel 20, the engagement of the limiting tab 53 with the flange 54 prevents the screen panels 20, 22 from moving. This facilitates joining the screen panels 20, 22.

As shown in FIG. 10E, once the trailing screen panel 22 is joined with the leading screen panel 20, the screen panel assembly 16 is lifted and moved forward in the direction of the access opening 14. In particular, lifting the trailing screen panel 22 causes the leading screen panel 20 to be lifted, and the two screen panels 20, 22 can be manipulated and moved at the same time. The assembly 16 is lifted so the limiting tab 53 of the leading screen panel 20 clears the flange 54 of the tray 42, as indicated by the arrow in FIG. 10E. The screen panel assembly 16 can be moved into the access opening 14.

FIG. 10F shows a third screen panel 23 being brought into position relative to the trailing screen panel 22 for joining therewith and incorporation into the screen panel assembly 16. The third screen panel 23 is substantially identical to and interchangeable with the screen panels 20, 22. The trailing screen panel 22 is situated so that its second limiting tab 53 engages the flange 54, as discussed above for the leading screen panel 20. The third screen panel 23 is brought into engagement and joined with the trailing screen panel 22 in a similar manner as discussed above for the leading and trailing screen panels 20, 22.

Once the third screen panel 23 is coupled with the trailing screen panel 22, it becomes part of the screen panel assembly 16. The screen panel assembly 16 is then lifted so that the limiting tab 53 of the trailing screen panel 22 clears the flange 54 of the tray, and the assembly 16 can be moved further into the access opening 14 (FIG. 10G).

FIG. 10H shows the screen panel assembly 16 substantially aligned with the tray 42 so that the locating bores 57 on the tongue 55 of the tray 42 are aligned with the locating bores 59 of the third screen panel 23. In that configuration, the limiting tabs 52, 53 of the third screen panel 23 are forward of the flange 54.

In addition, and as shown in FIG. 10I, the screen panel assembly 16 is secured to the tray 42 through the third screen panel 23. Particularly, the lugs 98 of the third screen panel 23 receive and engage the tongue 55 which extends from the flange 54 of the tray 42. The tongue 55 is received in the lug spacing 99 between the lug arm 97 and the ledge 90, and engages with the lug arm 97 to form a tight fit between the lugs 98 and the tongue 55.

Thereby, the screen panel assembly 16 and the agitating structure 18 are secured together and may be moved as a single piece and further inserted into the access opening 14, as shown in FIG. 10J. The main housing 12 includes locating brackets 140 formed near the access opening 14. The locating brackets 140 include locating bores 142, and the locating bores 57, 59 of the third screen panel 23 and the tray 42 can be moved into alignment with the locating bores 142 (FIG. 10J). A fastener 144 can be inserted into the locating bores 142, 57, 59 to secure the screen panel assembly 16, the agitating structure 18, and the main housing 12 together.

The screen panel assembly 16 and the agitating structure 18 can be removed from the screening machine 10, and separated from each other by reversing the above-described steps. While FIGS. 10A-10J show the installation of the screen panel assembly 16 and the agitating structure in the screening machine 10, it will be appreciated that reference may be made to those figures for understanding the following description of the removal.

If fasteners 144 are situated in the locating bores 142, 57, 59, the fasteners 144 can be removed. The screen panel assembly 16 and the agitating structure 18, which may be secured together through the engagement of the lugs 98 on the third screen panel 23 with the tongue 55 on the tray 42, can be moved somewhat out of the main housing 12 through the access opening 14. The connection can be broken between the lugs 98 on the third screen panel 23 and the tongue 55 by moving either the tray 42 or the screen panel assembly 16 so that the tongue 55 is removed from the lug spacing 99. Thereby, the screen panel assembly 16 is disconnected from the agitating structure 18.

The screen panel assembly 16 can then be moved further out of the access opening 14. In particular, the screen panel assembly 16 is moved until the flange 54 goes into the notch 50 on the trailing screen panel 22 (not shown). A small amount of further movement of the screen panel assembly 16 away from the access opening 14 brings the trailing edge 60 of the tab 52 on the trailing screen panel 22 into contact with the flange 54. This tends to inhibit further movement of the trailing screen panel 22 away from the access opening 14. With the trailing screen panel 22 being prevented from further movement, the third screen panel 23 can be separated from the trailing screen panel 22. With the third screen panel 23 removed from the screen panel assembly 16, the screen panel assembly 16 (which then includes the leading and trailing screen panels 20, 22) can be further removed and disassembled.

The screen panel assembly 16 is lifted so that the tab 52 of the trailing screen panel 22 clears the flange 54 of the tray 52, and the screen panel assembly 16 is moved further out of the access opening 14. The screen panel assembly 16 is moved until the flange 54 goes into the notch 50 on the leading screen panel 20.

Then, the trailing screen panel 22 can be separated from the leading screen panel 20 in a similar manner as described above for separating the third screen panel 23. Finally, the leading screen panel 20 can be removed from the tray 42 and separated completely from the agitating structure 18.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

What is claimed is:

1. A screen panel assembly for use with a screening machine, comprising:
first and second generally planar screen panels; and
a coupling between the screen panels including a projection from the first screen panel received in a receiving jaw of the second screen panel, the coupling further including a resilient biasing member carried by either the projection or the receiving jaw, the resilient biasing member being compressed between the projection and the receiving jaw.

2. The screen panel assembly of claim 1, wherein the receiving jaw includes an upper jaw portion and a lower jaw portion and a jaw opening defined between the upper and lower jaw portions, and wherein the resilient biasing member is carried by the receiving jaw and extends into the jaw opening.

3. The screen panel assembly of claim 2, wherein the resilient biasing member is carried by the lower jaw portion and extends in the jaw opening toward the upper jaw portion.

4. The screen panel assembly of claim 3, wherein the resilient biasing member is a compression clip having a generally U-shaped body having a first wing and a second wing, the first and second wings tending to resist deflection either toward or away from each other.

5. The screen panel assembly of claim 4, wherein the first wing of the compression clip is attached to the lower jaw portion and the second wing of the compression clip is not attached to the lower jaw portion.

6. The screen panel assembly of claim 5, wherein the lower jaw portion includes an upper surface and a lower surface, and wherein the first wing of the compression clip is attached to the lower surface of the lower jaw portion and the second wing of the compression clip extends above the upper surface of the lower jaw portion.

7. The screen panel assembly of claim 6, wherein the lower jaw portion further includes a terminal end and the first and second wings of the compression clip are connected through a junction region, and wherein the junction region is generally adjacent the terminal end of the lower jaw portion.

8. The screen panel assembly of claim 1, wherein the resilient biasing member is in the form of a generally planar leaf spring.

9. The screen panel assembly of claim 2, wherein the resilient biasing member is carried by the upper jaw portion and extends in the jaw opening toward the lower jaw portion.

10. The screen panel assembly of claim 1, wherein the resilient biasing member is carried by the projection.

11. The screen panel assembly of claim 1, wherein the coupling includes an overlap region between the first and second screen panels engageable to thereby permit lifting of the second screen panel by a lifting force exerted upon the first screen panel.

12. The screen panel assembly of claim 1, further comprising:
a seal member disposed between the first and second screen panels, the seal member being positioned on a top face of one of the first and second screen panels.

13. The screen panel assembly of claim 1, wherein the projection is along a terminal longitudinal edge of the first screen panel and is recessed relative to a top face of the first screen panel.

14. The screen panel assembly of claim 1, wherein the jaw is recessed relative to a top face of the second screen panel and relative to a terminal longitudinal edge of the second screen panel.

15. The screen panel assembly of claim 1 wherein the first and second screen panels are substantially identical and interchangeable with one another.

16. A screen panel configured to be coupled with a like screen panel as part of a screen panel assembly, comprising:
a frame;
a pre-tensioned screen supported on the frame;
a receiving jaw on a leading end of the frame;
a projection on a trailing end of the frame opposite the leading end, wherein the receiving jaw is configured to receive the projection of a like screen panel; and
a resilient biasing member carried by either the projection or the receiving jaw, the resilient biasing member being configured to be compressed between the receiving jaw and the projection of the like screen panel.

17. The screen panel of claim 16, wherein the receiving jaw includes an upper jaw portion and a lower jaw portion and a jaw opening defined between the upper and lower jaw portions, and wherein the resilient biasing member is carried by the receiving jaw and extends into the jaw opening, and wherein the resilient biasing member is a compression clip having a generally U-shaped body having a first wing and a second wing, the first and second wings tending to resist deflection either toward or away from each other.

18. The screen panel of claim 17, wherein the compression clip is carried by the lower jaw portion and extends in the jaw opening toward the upper jaw portion.

19. A screening machine comprising:
a main housing;
a screen panel assembly having first and second generally planar screen panels and a coupling between the screen panels configured to permit movement of the first and second screen panels by a force exerted upon the first screen panel,
the coupling between the screen panels including
(a) a projection from the first screen panel;
(b) a receiving jaw on the second screen panel configured to receive the projection;
(c) a resilient biasing member carried by either the projection or the receiving jaw, the resilient biasing member being compressed between the projection and the receiving jaw; and
(d) an overlap region between the first and second screen panels engageable to thereby permit lifting of the second screen panel by a lifting force exerted upon the first screen panel.

20. The screening machine of claim 19, wherein the resilient biasing member is a compression clip having a generally U-shaped body having a first wing and a second wing, the first and second wings tending to resist deflection either toward or away from each other.

21. A method of installing a screen panel assembly in a screening machine, comprising:
positioning a first screen panel on an agitating structure of the screening machine so that a limiting tab on the first screen panel engages a flange on the agitating structure,
joining a second screen panel with the first screen panel to form the screen panel assembly,
whereby the engagement of the limiting tab on the first screen panel with the flange on the agitating structure prevents the first screen panel from moving when then the second screen panel is joined with the first screen panel.

22. The method of claim 21, further comprising:
securing the screen panel assembly with the agitating structure.

23. The method of claim 22, wherein the second screen panel includes a lug and the agitating structure includes a tongue, and further wherein:
securing the screen panel assembly with the agitating structure includes securing the lug with the tongue.

24. The method of claim 22, further comprising:
joining a third screen panel with the second screen panel.

25. The method of claim 22, wherein the screening machine includes a main housing, and further comprising:
securing the screen panel assembly and the agitating structure with the main housing.
